(19) United States
(12) Patent Application Publication
(10) Pub. No.: US 2004/0247381 A1
(43) Pub. Date: Dec. 9, 2004

(54) Spring clip with a u-shaped profile for flange connections

(76) Inventor: Lothar Bruckner, Leonberg (DE)

Correspondence Address: WILLIAM COLLARD, COLLARD & ROE, P.C., 1077 NORTHERN BOULEVARD, ROSLYN, NY, 11576, US

(21) Appl. No.: 10/492,575

(22) PCT Filed: Jan. 30, 2003
(86) PCT No.: PCT/DE03/00248

(30) Foreign Application Priority Data
Feb. 2, 2002 (DE) 102 04 262.4

(51) Int. Cl. F16B 1/00; F16D 1/00; B25G 3/00; F16G 11/00

(52) U.S. Cl. 403/286

(57) ABSTRACT

The invention relates to a one-piece spring clip with a U-shaped profile, consisting in particular of spring steel, for flange connections, in a particular for flange connections of the exhaust gas pipes of motor vehicles. Said clip comprises first openings (3) that extend from a region of the spring-loaded back (1) to the ends of the two limbs with a U-shaped profile (2) for receiving the pipes that are connected by means of flanges. The aim of the invention is to provide a spring clip that is easy to produce, lightweight and has excellent spring-loaded characteristics. This is achieved by a flange connection that is provided with at least one second opening (4) with a closed circumference, in the form of a through-opening in the region of the spring-loaded back (1), said opening covering the vertex region of said back.

This invention relates to a spring clip with a U-shaped profile for flange connections according to the preamble of the patent claim.

Such spring clips are known from WO 99/02912 and DE 100 15 028 C1.

In comparison with the embodiment in the publication cited first, the publication cited last describes a thinning of material in the rear area of the spring due to large first openings according to this invention in the direction of the zenith of the back of the spring. At least one of the two first openings may extend beyond the zenith of the back of the spring.

This invention is concerned with the problem of producing a generic spring clip by the simplest possible method while at the same time achieving the best possible spring effect with the lowest possible weight.

This object is achieved by a generic spring clip having the characterizing features of the patent claim.

The opening in the curved back area of the spring clip, which is closed around the periphery according to this invention, has the following advantages in comparison with the generic first openings according to DE 100 15 028 C1 which are open toward the ends of the spring legs and protrude into the area of the back of the spring:

Reduced weight of the spring clip

Facilitated bending of the spring clip due to

1.) reduced material in the bent area of the spring clip to reduce the bending forces,

2.) the rear area of the spring clip which is between the U-shaped legs can be designed favorably in terms of bending since this area of material can be designed to be large enough. Favorable in terms of bending here means that a bending process which is gentle to the material can take place in contrast with a press operation which is necessarily the result of an area of material that cannot be designed to be large enough,

the bent spring clip area with a opening is softer from the standpoint of rigidity, so the spring characteristic of the clip is softer; the load peaks in the legs close to the bend are reduced,

the opening through the material improves the dissipation of heat of a spring clip inserted into an exhaust gas system, because the relative wind (slipstream) created by driving can pass through the spring clip better and more uniformly (wind shadow effects).

An advantageous exemplary embodiment of this invention is depicted in the drawings, which show:

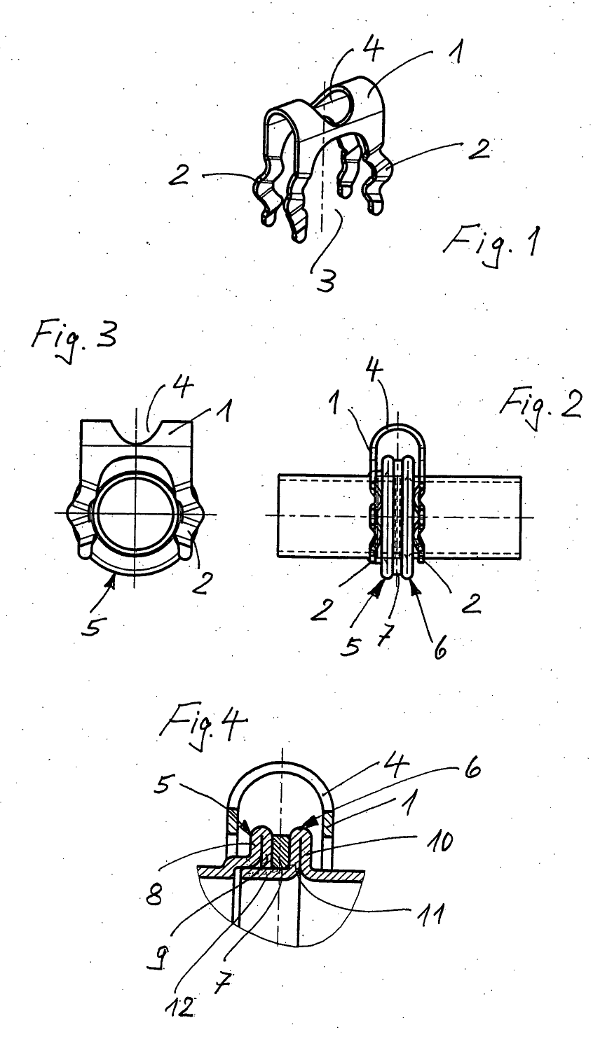

FIG. 1 a perspective view of a spring clip which can be attached to flange connections,

FIG. 2 the spring clip in a first view showing it mounted to achieve a flange connection,

FIG. 3 a side view of the flange connection shown in FIG. 2,

FIG. 4 an enlarged detail of the flange connection in FIG. 2.

The spring clip has a curved spring-loaded back 1 and opposing legs 2 adjacent to the area of the spring-loaded back 1, a pair of legs being opposite one another with respect to a longitudinal plane passing through the spring-loaded back 1. The legs 2 delineate the first openings 3 in the plane of each pair of these legs. The material of the spring clip is bent spring steel, so that the legs 2 function as spring arms or spring tongues. To save on material, to facilitate the manufacture of the spring clips and to improve upon the spring action of the spring clips, a second opening 4 is provided in the spring-loaded back 1 in the form of a through-opening, which is closed on the periphery and encompasses the zenith of the spring-loaded back 1.

In the case of an assembled flange connection, the spring clip is attached to the joined flanges, with the legs 2 fixedly clamping the opposing flanges, namely a first flange 5 and a second flange 6, axially against one another over a sealing ring 7 inserted between them. The first flange 5 is designed as a flared flange, whereby a second flange area 9 which serves as the mating surface in relation to the second flange 6 is bent back by 180° onto a first flange area 8 which is bent radially outward at a right angle. The second flange area 9 which is bent back has a recess on the inside radially with respect to the base area of the first flange area 8.

With the second flange 6, a first flange area 10 is also bent radially outward at a right angle, with a radial return bend by 180° extending as a second flange area 11 from the side facing the first flange 5, with the end area being bent by 90° again to a third flange area 12. The third flange area 12 of the second flange 6 has a central outside circumference, which is centered in relation to the pipe of which the second flange 6 is formed. The diameter of this outside circumference is selected so that radial centering is achieved by axial insertion into the second flange area 9 of the first flange 5. The sealing ring 7, which is clamped between the first and second flanges 5 and 6 respectively is centered radially on the third flange area 12 or the second flange 6.

1. A one-piece U-shaped spring clips made of bent spring steel in particular, for flange connections, in particular for the flange connections on exhaust gas pipes of motor vehicles, comprising first openings that extend from a region of the spring-loaded back to the ends of the two U-shaped legs and completely pass through each of the U-shaped legs, for receiving the pipes that are connected by the flanges,
wherein at least one second opening (4) which has a closed circumference that encompasses the zenith area of the spring-loaded back is provided in the form of a through-opening in the area of the spring-loaded back (1).
